(19) United States
(12) Patent Application Publication
(10) Pub. No.: US 2015/0284623 A1
(43) Pub. Date: Oct. 8, 2015

(54) BORON-CONTAINING OIL WELL FRACTURING FLUID

(71) Applicant: Nabors Completion & Production Services Co., Houston, TX (US)

(72) Inventors: David E. SCHWAB, Renfrew, PA (US); Matthew BLAUCH, Columbia, MO (US); Michael GUILLOTTE, Katy, TX (US); Bradley KAUFMAN, The Woodlands, TX (US)

(21) Appl. No.: 14/671,532

(22) Filed: Mar. 27, 2015

Related U.S. Application Data
(60) Provisional application No. 61/974,558, filed on Apr. 3, 2014.

(51) Int. Cl. C09K 8/68

(52) U.S. Cl. CPC C09K 8/68

(57) ABSTRACT

A water source comprising a boron containing compound. The water source can have a boron concentration of not greater than 0.05 moles per liter. The water source further comprising a polyol. The polyol having a concentration of at least N times 0.05 moles per liter, wherein the water source is free of any boron-containing solid and has a dynamic viscosity of less than 100 cp.

### CROSS-REFERENCE TO RELATED APPLICATION(S)

This application claims priority under 35 U.S.C. §119(e) to U.S. Patent Application No. 61/974,558, entitled “BORON-CONTAINING OIL WELL FRACTURING FLUID,” by David E. Schwab, Matthew Blauch, Michael Guillotte, and Bradley Kaufman, filed Apr. 3, 2014, which is assigned to the current assignee hereof and incorporated herein by reference in its entirety.

### FIELD OF THE DISCLOSURE

The present invention relates to viscous well treating fluids and methods of using the fluids for treating subterranean zones.

### RELATED ART

The production of oil and natural gas from an underground well (subterranean formation) can be stimulated by a technique called hydraulic fracturing, in which a viscous fluid composition (fracturing fluid) containing a suspended proppant (e.g., sand, bauxite) is introduced into an oil or gas well via a conduit, such as tubing or casing, at a flow rate and a pressure which create, reopen and/or extend a fracture into the oil- or gas-containing formation. The proppant is carried into the fracture by the fluid composition and prevents closure of the formation after pressure is released. Leak-off of the fluid composition into the formation is limited by the fluid viscosity of the composition. Fluid viscosity also permits suspension of the proppant in the composition during the fracturing operation. Cross-linking agents, such as borates, titanates or zirconates are usually incorporated into the composition to control viscosity.

High viscosity aqueous cross-linked gels are used in a variety of operations and treatments carried out in oil and gas wells. Such operations and treatments include, but are not limited to, production stimulation treatments, well completion operations, fluid loss control treatments and treatments to reduce water production.

An example of a production stimulation treatment utilizing a high viscosity cross-linked gelled fluid is hydraulic fracturing. In hydraulic fracturing treatments, the high viscosity fluid is utilized as a fracturing fluid and a carrier fluid for the proppant. That is, the high viscosity fluid is pumped through the well bore into a subterranean zone to be fractured at a rate and pressure such that fractures are formed and extended in the zone. The proppant is suspended in the fracturing fluid so that the proppant is deposited in the fractures. The fracturing fluid is then broken into a thin fluid and returned to the surface. The proppant functions to prevent the fractures from closing whereby conductive channels are formed through which produced fluids can flow to the well bore.

A variety of cross-linking compounds and compositions have heretofore been utilized for cross-linking gelled aqueous well treating fluids. Various sources of borate have been utilized including boric acid, borax, sodium tetraborate, slightly water soluble borates such as ulexite, and other proprietary borate compositions such as polymeric borate compounds. Various compounds that are capable of releasing multivalent metal cations when dissolved in aqueous well treating fluids have also been used heretofore for cross-linking gelled aqueous well treating fluids. Examples of the multivalent metal ions are chromium, zirconium, antimony, titanium, iron, zinc and aluminum.

Delayed cross-linking compositions have also been utilized heretofore such as compositions containing borate ion producing compounds, chelated multivalent metal cations or mixtures of organotitanate compounds and polyhydroxyl containing compounds such as glycerol. However, high viscosity aqueous gels cross-linked with the above described cross-linking agents and compositions have encountered operational problems. That is, water comprising a crosslinker, such as soluble borates, may accelerate crosslinking to the high viscosity cross-linked gelled aqueous well treating fluids. Likewise, the presence of excess amounts of crosslinker or crosslinker present in the source water, e.g., borates, can delay or make it difficult to break the gelled treating fluid after being placed in a subterranean zone and upon fracturing, thereby leaving residue in the subterranean zone, both of which interfere with the flow of produced fluids from the treated zone.

Moreover, produced water, i.e. water obtained after the breaking of the treating fluid contain crosslinkers such as borates which are difficult to separate from the produced water, thus diminishing the use of produced water for subsequent preparation of treating fluids.

Thus, there are needs for improved high temperature well treating fluids and methods of using such fluids wherein the fluids require less gelling agent thereby reducing the residue left in subterranean zones treated therewith and the treating fluids have high viscosities which are stable over time at high temperatures.

Accordingly, the industry continues to demand improvements in subterranean drilling operations.

### SUMMARY OF THE INVENTION

In a first aspect, a water source comprising a boron containing compound. The boron containing can have a boron concentration of not greater than 0.05 moles per liter. The water source can further include a polyol. The polyol can have a concentration of at least N times 0.05 moles per liter. In one embodiment, the water source can be free of any boron-containing solid. In another embodiment, the water source can have a dynamic viscosity of less than 100 cp.

In a second aspect, a method of treating a water source includes providing water from a water source. In embodiments, the water includes a boron containing compound. The method further includes adding a polyol to the water.

In a third aspect, a method of preparing a fracturing fluid includes providing water from a water source. The water includes a boron containing compound. The method can further include adding a polyol to the water and adding a polysaccharide-based polymer to the water.

### BRIEF DESCRIPTION OF THE DRAWINGS

Embodiments are illustrated by way of example and are not limited in the accompanying figures.

FIG. 1 includes a comparison graph of a viscosity profile in accordance with an embodiment to the invention.

FIG. 2 includes a second comparison graph of a viscosity profile in accordance with an embodiment to the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the drilling arts.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In the oilfield technology, crosslinkable polysaccharides, such as guar, methylcellulose, or derivatives thereof are used as aqueous viscosifiers to obtain a viscosity profile suitable for fracturing operations. Crosslinking of these polysaccharides results in a significant increase in the viscosity of the fluid. A common crosslinker used in these applications is boron in form of borate, B(OH)₄⁻ and salts thereof.

Boron is often present in the waters used to hydrate viscosifying polysaccharides. The presence of boron can occur naturally or, is present from previous operations employing boron, i.e. in produced waters. The presence of boron in the water used to hydrate polysaccharides can cause pre-mature and/or undesired crosslinking of the polysaccharides.

A fracturing operation is time-sensitive undertaking, where the treating fluid or fracturing fluid needs to maintain a certain low viscosity as it is pumped downhole to the fracturing site. A high viscosity is desired at the fracturing site to achieve optimum fracturing results. Shortly after the fracturing operation, the treating fluid is to break, i.e. loses viscosity to a level that allows the fluid to be pumped back to the surface.

It follows, if the crosslinking occurs due to presence of a crosslinker such as boron in the waters, the viscosity profile can be affected. Even low concentration of boron (<20 ppm B) can cause elevated initial viscosity and affect hydraulic fracturing job execution, thereby creating undesired increased wellhead pressures and ineffective proppant transport downhole.

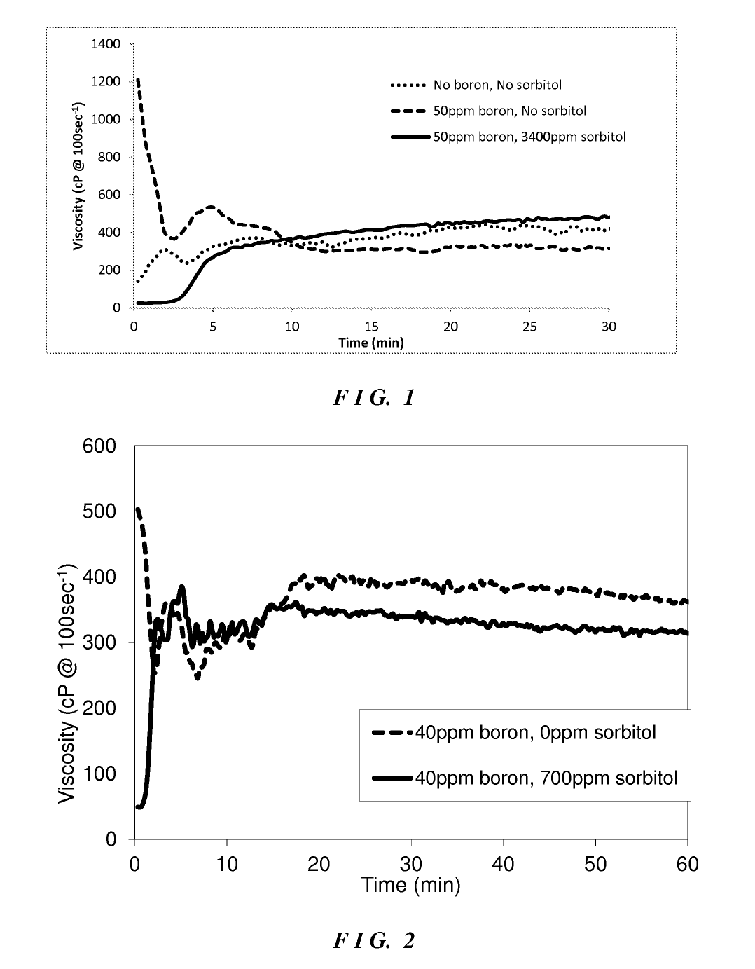

Referring to FIG. 1, disclosing a viscosity profile of three liquids all containing the same amount of viscosifier (guar), the dashed line shows the viscosity profile after the pH of the fluid has been increased from 7 to 12 in water comprising 50 ppm of boron, which causes an initial viscosity of more than 1200 centipoise. In comparison, the dotted line shows the initial viscosity of the liquid in the absence of boron in the water at about 140 centipoise after the equivalent change in pH. It follows that the relative small amount of boron present in a water source can cause at least an 8-fold increase in the initial viscosity of a treating fluid as the pH is adjusted on-the-fly in the presence of a viscosifier in water from such water source.

This multi-fold increase makes boron-containing water undesirable and the presence of boron can prevent a water source from being used, requiring the location of a suitable water source, often a time consuming and costly endeavor. It follows that waters contaminated with boron are treated by methods to separate boron or used for a different purpose than fracturing operation. Of course, boron treatment require additional time, labor, equipment, and handling or transport of the water.

One approach for removing boron is the use of reverse osmosis (“RO”) membranes. The small size of boron allows significant amounts of boron to pass through the RO membranes. When processing large quantities of water, as are required for hydraulic fracturing operations, the use of RO membranes is not practical. Additionally, the presence of other contaminants, common in recycled hydraulic fracturing water, causes the rapid fouling of RO membranes.

Another approach for boron contamination is also addressed through the use of ion exchange resins. The quantity of ion exchange resin necessary for large scale operations can be cost prohibitive. This approach is also difficult to implement in remote locations, such as in the oilfield, and requires the use and disposal (or evaporation) of large quantities of regeneration water.

A third approach, boron can also be removed by the formation of a sparingly soluble precipitate. This is done by addition of calcium hydroxide at an elevated temperature. The application of this approach is limited by the need to heat the water to improve the efficiency of the process. This would add significant energy costs. Additionally, the solids generated have to be filtered or allowed to settle. Disposal of these solids must also be considered.

In a first aspect, a water source comprising a boron containing compound. The boron containing compound can have a boron concentration of not greater than 0.05 moles per liter. The water source can further include a polyol. The polyol can have a concentration of at least N times 0.05 moles per liter. In one embodiment, the water source can be free of any boron-containing solid. In another embodiment, the water source can have a dynamic viscosity of less than 100 cp.

The above listed approaches can be replaced or combined with a method for treating waters containing boron using low-molecular weight polyols to reduce or inhibit the undesired initial crosslinking of viscosifiers.

Water-soluble polysaccharides, such as guar & xanthan gums, are used as viscosifiers/thickeners in a wide variety of applications. Many water-soluble polysaccharides can be crosslinked by boron. Crosslinking by boron occurs when the pH of the solution is raised to ˜9.5 or higher. Free boron in aqueous solution exist in equilibrium between boric acid, B(OH)₃, and borate, B(OH)₄⁻. As the pH is raised from 7 to 10, the equilibrium shifts towards borate, wherein at pH>10, the borate is substantially present (>99%).

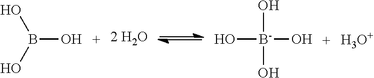

In the presence of polysaccharides, borate crosslinks by interacting with cis-diol functional groups on polysaccharides. Cis-diols are functional groups having two hydroxyl groups at a dihedral angle of less than 120 degrees. In other words, the hydroxyl groups are sterically in such a configuration to easily replace to hydroxyl groups of the borate ion. Cis-diols are found on sugar residues such as glucose and mannose. Crosslinking occurs when borate exchanges two of its hydroxyl groups for two hydroxyls of a cis-diol on one polysaccharide and the other two hydroxyl groups for two from a cis-diol on another polysaccharide, linking the two polysaccharides together. When this occurs repeatedly throughout a solution, the viscosity of the solution increases substantially.

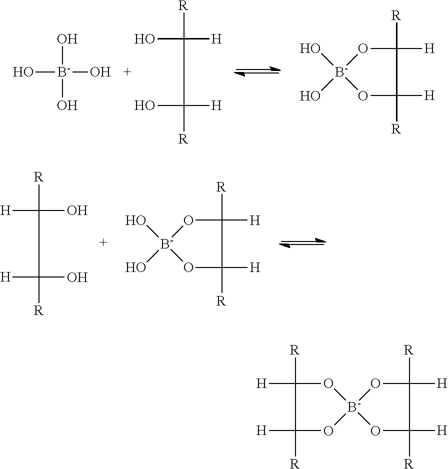

When a crosslinkable, water-soluble polysaccharide is hydrated in water contaminated with boron, crosslinking can occur if the pH is, or later becomes, alkaline. The present invention is a method to treat water containing the undesired presence of boron with low molecular weight polyols to prevent crosslinking from occurring when crosslinking is unwanted.

In one embodiments, the polyols have a low molecular weight. For example, the molecular weight is less than 1,000 grams per mole, such less than 900 grams per mole, less than 800 grams per mole, less than 700 grams per mole, less than 600 grams per mole, less than 500 grams per mole, less than 400 grams per mole, less than 300 grams per mole, or less than 200 grams per mole.

In another embodiment, the polyols have at least one 1,2-cis diol. For example, a C-6 polyol with 3 cis-hydroxyl groups is sorbitol. Another polyol with cis-configuration hydroxyl groups is glucose monosaccharide and its disaccharide homolog, maltose.

In another embodiment, the polyol can have one or more 1,3-cis diols per molecule, such as sorbitol, mannitol, and fructose. The polyols form a complex with boron in the same way a polysaccharide complexes with boron. However, the formation of the polyol-boron complex occurs at a faster rate than the boron complexation with the polysaccharide. As a result, there is substantially no free boron, meaning a borate ion without a complex, such as a B(OH)₄⁻.

Because of the low molecular weight of the polyols, no increase in solution viscosity occurs when the polyols complex with boron. By complexing the boron with polyols, the unwanted premature crosslinking of the polysaccharides by boron and the accompanying high intermediate viscosity is eliminated. As can be seen in FIG. 1., when sorbitol is present at a concentration of 3400 ppm, the viscosity remains below 50 cp until additional crosslinker is added at about 3 min to gel the treating liquid. In fact the presence of polyol even maintains a lower initial viscosity compared to water that is free of sorbitol and boron.

As can be seen further in FIG. 1, the presence of sorbitol has no negative impact on the final viscosity. In fact, the sorbitol containing liquid actually has a higher final viscosity (>400 cp) than the untreated initial boron-containing liquid (dashed line) with a final viscosity at about 300 cp. This result is probably due to the effect that not the entire amount of polysaccharide has dissolved in water but has over-crosslinked, i.e. an effect where the polysaccharide no longer acts as a viscosifier but partially precipitates or does not dissolved.

In one embodiment, the method of treatment is to add the polyol to the boron-containing water prior to hydration of the water-soluble polysaccharides. This allows for the polyol to associate with the boron present in the water, prior to polysaccharide addition. An alternate method would be to add the polyol to the water at the same time as the polysaccharide is being added to the water. A further method is to add the polyol following guar hydration, but prior to addition of any base used to raise the pH above ˜8.5.

The dosage of polyol can be determined by the concentration of boron in the water and also based upon the proposed use of the fluid. Crosslinking can be prevented by binding one polyol to each boron atom. However, because each boron atom can complex with two polyols, homogenous distribution of the polyols is unlikely. Therefore, molar excess of polyol to boron is recommended.

In one embodiment, the presence of small amounts of free boron (i.e. <5 ppm) does not significantly increase the viscosity of polysaccharide solutions. Therefore, complexation of 100% of the free boron is not necessary for acceptable fluid properties on the surface at the well pad site. The polyol dosage must be sufficient to maintain the fluid viscosity at or below the viscosity threshold, which is determined by the process in which the fluid is used. Accordingly, amounts of polyol can be chosen to result that at least 1 ppm is free boron, i.e. free borate B(OH)₄⁻, at least 2 ppm is free borate B(OH)₄⁻, at least 3 ppm is free borate B(OH)₄⁻, at least 4 ppm is free borate B(OH)₄⁻, or at least 5 ppm is free borate B(OH)₄⁻.

The dosage of polyol is also dependent upon the use of the fluid. In some processes, all crosslinking is undesirable, while in other cases, crosslinking may be required at a later point in the process. If no crosslinking is desired at any point in the process, excess polyol can be added to prevent boron in the water from crosslinking the polysaccharides. Accordingly, the amount of polyol can be stoichiometrically the same amount, double, triple, fourfold, fivefold, tenfold or more to control the initial viscosity. The amount of polyol can be twentyfold, thirtyfold, fiftyfold, hundredfold, or higher to inhibit the formation of the thickened liquid.

When crosslinking is desired at a later point in the process, the concentration of polyol should be adjusted to react with the boron in the water and a delayed crosslinker added to the fluid. Such a process maintains the low solution viscosity until the delayed crosslinker is activated. The dosage of crosslinker used after treatment with polyol may require adjustment to account for the additional boron present in the water.

It is a feature of this disclosure that the degree of acidity of a gelling agent affects the viscosity profile of the same. Accordingly, the present discovery allows for another tool of manipulating the viscosity of fracturing fluids namely by adjusting or controlling the pH of the fluid. Secondarily, the viscosity profile of fracturing fluids can also be adjusted by controlling the pKₐ of the gelling agent. The pKₐ of the gelling agent is primarily a function of the type of acidic moieties grafted to the gelling agent polymeric units. Acidic groups can include carboxy groups, ammonium groups, sulfonate groups, phosphonate groups, and a combination thereof. Accordingly, the resulting pKₐ depends on numbers and types of such groups in the polymer of the gelling agent. The pKₐ can also be affected by secondary groups such as alkylene groups attached to the acidic groups. For example, the polymer can include carboxymethyl groups (—CH₂—COOH), carboxyethyl groups (—CH₂CH₂—COOH), carboxypropyl groups (—CH₂CH₂CH₂—COOH), and halogenated derivatives thereof, such as fluorinated carboxyalkyl groups, e.g. —CF₂—COOH, —CF₂CF₂—COOH, —CF₂CF₂CF₂—COOH, or mixed forms such as —CH₂CF₂—COOH. In another embodiment, the polymer can include aminomethyl groups (—CH₂—NH₂), aminoethyl groups (—CH₂CH₂—NH₂), aminopropyl groups (—CH₂CH₂CH₂—NH₂), and halogenated derivatives thereof, such as fluorinated carboxyalkyl groups, e.g. —CF₂—NH₂, —CF₂CF₂—NH₂, —CF₂CF₂CF₂—NH₂, or mixed forms such as —CH₂CF₂—NH₂.

FIG. 1 illustrates the change in the viscosity profile based on the presence of boron and/or sorbitol. The details of the fracturing liquids prepared is described in the Experimental section. As can be seen in FIG. 1, the gelling of boron containing water that includes also sorbitol (solid line) rises to a viscosity above 400 cP at approximately 12 minutes and 9 minutes after addition of the total amount of cross linker and remains at that or higher viscosity. On the other hand, a liquid containing boron but no polyol has an initial viscosity of more than 1200 cp and it takes 10 minutes until that viscosity drops to the desired level of about 300 to 400 cp. It is noted that both fluids contained the same buffer at pH 12, stabilizer and cross-linking agent and amounts thereof. The difference between the two lines is that, when present, sorbitol has a 4-fold greater concentration than the concentration of boron. (MW(sorbitol)=128 g/mol; MW(B)=10.8 g/mol; 3400/128=18.7 mol/t; 50/10.81=4.63 mol/t→18.7/4.63=4.04)

Thus, in one embodiment, a polyol containing treating liquid can insure low to high viscosity kinetics over the course of 12 minutes

As can be seen in FIG. 2, sorbitol is present at about an equal molar concentration to that of boron. (MW(sorbitol)=128 g/mol; MW(B)=10.8 g/mol; 700/128=5.47 mol/t; 40/10.81=3.70 mol/t→5.47/3.70=1.48). The treating liquid reaches the target viscosity of about 300 cp at the same time as the sorbitol free fluid (dashed line). However, in an on-the-fly operation the initial high viscosity would operationally cause friction pressure problems where the sorbitol free fluid would pump at higher pressure than the sorbitol-containing fluid downhole.

In a second aspect, a method of preparing a fracturing fluid includes hydrating a polysaccharide in water. The water including at least 100 ppm of a polyol. The method further includes adjusting the pH of the hydrated polysaccharide to more than 8. The method can further include mixing at least one additional agent with the fracturing fluid. The additional agent can be selected from oxygen scavenger, a cross-linking composition, a gel breaker, a proppant, or any combination thereof.

The pH can be adjusted to less than 13.5, less than 13, less than 12.5, less than 12, less than 11.5, less than 11, less than 10.5, less than 10, less than 9.5, or less than 9. In one embodiment, the pH can be at least 8.5, at least 9, at least 9.2, at least 9.5, at least 9.8, at least 10, at least 10.2, at least 10.5, at least 10.7, at least 11, at least 11.2, at least 11.5, or at least 11.8. In one embodiment, the pH can range between 8.5 and 12.5, such as between 10.5 and 12.3, or between 11 and 12.

In a third aspect, a method of treating a subterranean zone penetrated by a well bore can include preparing a viscous well treating fluid comprised of water, a gelling agent, a cross-linking composition, and a polyol. The treating fluid can further include an oxygen scavenger or a delayed gel breaker. The method can further include pumping said well treating fluid into said zone by way of said well bore at a rate and pressure sufficient to treat said zone during which said hydrated gelling agent in said treating fluid is cross-linked by said retarded cross-linking composition. The method can further include allowing said viscous treating fluid to break into a thin fluid.

In one embodiment, the gelling agent can be selected from the group consisting of a galactomannan, a glucomannan, a cellulose, and a combination thereof.

In another embodiment, the low residue fracturing fluid can include a mixture of gelling agents. The additional gelling agent can be selected from the group consisting of a galactomannan, a glucomannan, a cellulose, and a combination thereof. In one embodiment, the mass ratio of first gelling agent to a total of first gelling agent and additional gelling agent ranges from 1 wt % to 99 wt %, such as from 10 wt % to 95 wt %, from 20 wt % to 90 wt %, from 30 wt % to 85 wt %, from 40 wt % to 80 wt %, or from 50 wt % to 75 wt %.

In yet one further embodiment, the additional gelling agent is a carboxylated gelling agent. The carboxylated gelling agent is selected from carboxymethyl cellulose, carboxylated hydroxypropyl cellulose, carboxymethyl hydroxyethyl cellulose, carboxymethyl hydroxypropyl cellulose, carboxymethyl guar, carboxylated hydroxypropyl guar, carboxymethyl hydroxyethyl guar, carboxymethyl hydroxypropyl guar, carboxymethyl xanthan, carboxylated hydroxypropyl xanthan, carboxymethyl hydroxyethyl xanthan, carboxymethyl hydroxypropyl xanthan, or any combination thereof.

The low residue fracturing fluid can further include a cross-linking agent. The cross-linking agent includes metal salt. The metal can be selected from boron, aluminum, zirconium, iron, antimony, titanium, or any combination thereof. In one embodiment, the metal comprises zirconium. In another embodiment, the metal consists essentially of zirconium. In another embodiment, the metal salts can include a zirconium(IV) salt. In one particular embodiment, the zirconium(IV) salt can include zirconium oxychloride. In yet another embodiment, the crosslinking agent is a boron compound.

In another embodiment, the fracturing fluid can include an additional chelating agent. The chelating agent can be selected from a diol, a diamine, a dicarboxylic acid, a carboxylic acid, an alkanol amine, a hydroxycarboxylic acid, an aminocarboxylic acid, or any combination thereof. In a particular embodiment, the chelating agent can be a citrate, a lactate, or an acetate. In another embodiment, the chelating agent can be ethylenediaminetetraacetic acid, ethylene glycol tetraacetic acid, or any combination thereof. In yet one further embodiment, the alkanol amine includes triethanolamine.

In one embodiment, the cross-linking agent can be present in an amount of at least 0.1 gpt (gallons per thousand gallons), such as at least 0.15 gpt, at least 0.2 gpt, at least 0.25 gpt, at least 0.3 gpt, at least 0.4 gpt, at least 0.5 gpt, at least 0.6 gpt, at least 0.7 gpt, at least 0.8 gpt, at least 0.9 gpt, at least 1 gpt, at least 1.1 gpt, at least 1.3 gpt, or at least 1.5 gpt. In another embodiment, the cross-linking agent can be present in an amount of not greater than 2 gpt (gallons per thousand gallons), such as not greater than 1.8 gpt, not greater than 1.6 gpt, not greater than 1.4 gpt, not greater than 1.2 gpt, not greater than 1 gpt, not greater than 0.9 gpt, not greater than 0.8 gpt, not greater than 0.7 gpt, not greater than 0.6 gpt, or not greater than 0.55 gpt.

In yet another embodiment, the low residue fracturing fluid further includes an oxygen scavenger. The oxygen scavenger can include a sulfur containing compound. The sulfur containing compound can be selected from thiosulfates, sulfites, bisulfites, or any combination thereof. The oxygen scavenger can be present in an amount of at least 1 wt %, such as at least 1.5 wt %, at least 2 wt %, at least 2.5 wt %, at least 3 wt %, at least 4 wt %, or at least 5 wt %. The oxygen scavenger can be present in an amount of not greater than 10 wt %, such as not greater than 9 wt %, not greater than 8 wt %, not greater than 7 wt %, not greater than 6 wt %, not greater than 5.5 wt %.

In one embodiment, the low residue fracturing fluid can have a peak viscosity at 175 degF of at least 4000 cP per wt % amount of acidified carboxylated gelling agent. Accordingly, if the acidified carboxylated gelling agent is present in an amount of 0.25 wt %, the peak viscosity at 175 deg F. is 0.25 times 4000, cP i.e., 1000 cP. In another embodiment, the low residue fracturing fluid maintains a viscosity at 220 deg F. of at least 2000 cP per wt % amount of acidified carboxylated gelling agent for 45 minutes.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

The concepts are better understood in view of the embodiments described below that illustrate and do not limit the scope of the present invention. The embodiments provide a combination of features, which can be combined in various matters to describe and define a method and system of the embodiments. The description is not intended to set forth a hierarchy of features, but different features that can be combined in one or more manners to define the invention. In the foregoing, reference to specific embodiments and the connection of certain components is illustrative. It will be appreciated that reference to components as being coupled or connected is intended to disclose either direct connected between said components or indirect connection through one or more intervening components as will be appreciated to carry out the methods as discussed herein.

As such, the above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The disclosure is submitted with the understanding that it will not be used to interpret or limit the scope or meaning of the claims. In addition, in the foregoing disclosure, various features may be grouped together or described in a single embodiment for the purpose of streamlining the disclosure. This disclosure is not to be interpreted as reflecting an intention that the embodiments herein limit the features provided in the claims, and moreover, any of the features described herein can be combined together to describe the inventive subject matter. Still, inventive subject matter may be directed to less than all features of any of the disclosed embodiments.

The following is a list of non-limiting items that fall within the scope of the present disclosure:

1. A water source comprising a boron containing compound, having a boron concentration of not greater than 0.05 moles per liter, and a polyol, the polyol having a concentration of at least N times 0.05 moles per liter, wherein the water source is free of any boron-containing solid and has a dynamic viscosity of less than 100 cp.

2. The water source according to item 1, wherein the boron containing compound is selected from the group consisting of boric acid, borate, tetrahydroxyborate, metaborate, polyborate, or any combination thereof.

3. The water source according to any one of the preceding items, wherein the polyol is selected from the group consisting of C₂-C₆ polyols, C₂-C₆ sugar alcohols, C₂-C₆ monosaccharides, disaccharides made from C₂-C₆ monosaccharides, trisaccharides made from C₂-C₆ monosaccharides, C₂-C₆ sugar acids, C₂-C₆ amino sugars, and any combination thereof.

4. The water source according to any one of the preceding items, wherein the polyol is selected from the group of glycols, glycerin, glucose, sorbitol, dextrose, mannose, mannitol, and any combination thereof.

5. The water source according to any one of the preceding items, wherein N is at least 0.1, such as at least 1.1, at least 1.5, at least 1.8, at least 2, at least 2.1, at least 2.2, at least 2.3, at least 2.4, at least 2.5, at least 3, at least 3.5, at least 4, at least 4.5, at least 5, at least 6, at least 8, at least 10, at least 20, at least 30, at least 40, at least 50, at least 75, at least 100.

6. The water source according to any one of the preceding items, wherein N is not greater than 1000, not greater than 900, not greater than 800, not greater than 700, not greater than 600, not greater than 500, not greater than 450, not greater than 400, not greater than 350, not greater than 300, not greater than 250, not greater than 200, not greater than 150, not greater than 125, not greater than 110, not greater than 90, not greater than 70, not greater than 50, not greater than 30, not greater than 25, or not greater than 15.

7. The water source according to any one of the preceding items, wherein the water source includes a well water source, a riparian water source, an aquifer water source, a lake water source, an ocean water source, a surface water source, a subterranean water source, an industrial water source, a waste water source, production water, flowback water, or any combination thereof.

8. The water source according to any one of the preceding items further comprising a buffer.

9. The water source according to any one of the preceding items, wherein the water source has a pH greater than 4, such as greater than 4.5, greater than 5, greater than 5.5, greater than 6, greater than 7, greater than 8, greater than 9, greater than 9.5, greater than 10, greater than 10.1, greater than 10.2, greater than 10.3, greater than 10.4, or greater than 10.5.

10. The water source according to any one of the preceding items, wherein the water source has a pH not greater than 12.5, not greater than 12, not greater than 11.5, such as not greater than 11, not greater than 10.8, not greater than 10.6, not greater than 10.4, not greater than 10.3, not greater than 10.2, not greater than 10.1, not greater than 10.

11. The water source according to any one of the preceding items, wherein the boron concentration is a minimum of 9.25×10⁻⁸ moles per liter.

12. The water source according to any one of the preceding items, wherein the water source is in an amount of at least 100 gallons, at least 500 gallons, at least 1000 gallons, at least 1500 gallons, at least 2000 gallons, at least 5000 gallons, at least 7500 gallons, at least 10,000 gallons, at least 50,000 gallons, at least 100,000 gallons.

13. The water source according to any one of the preceding items, wherein the water source is in an amount of not greater than 1000 Mega-gallons (Mgal), not greater than 500 Mgal, not greater than 200 MGal, not greater than 100 MGal, not greater than 80 MGal, not greater than 60 MGal, not greater than 40 MGal, not greater than 20 MGal, not greater than 10 MGal, not greater than 50 MGal, or not greater than 1 MGal.

14. A method of treating a water source, the method comprising:

providing water from a water source, the water comprising a boron containing compound;

adding a polyol to the water.

15. A method of preparing a fracturing fluid, the method comprising:

providing water from a water source, the water comprising a boron containing compound;

adding a polyol to the water;

adding a polysaccharide-based polymer.

16. The method according to any one of items 14 and 15, wherein the wherein the polyol is selected from the group consisting of C₂-C₆ polyols, C₂-C₆ sugar alcohols, C₂-C₆ monosaccharides, disaccharides made from C₂-C₆ monosaccharides, trisaccharides made from C₂-C₆ monosaccharides, C₂-C₆ sugar acids, C₂-C₆ amino sugars, and any combination thereof.

17. The method according to any one of items 14 through 16, wherein the polyol is selected from the group of glycols, glycerin, glucose, sorbitol, dextrose, mannose, mannitol, and any combination thereof.

18. The method according to any one of items 14 through 17, further comprising determining a concentration of the boron containing compound.

19. The method according to item 18, wherein the determining of the boron containing concentration is conducted prior to adding the polyol, after adding the polyol, or prior and after adding the polyol.

20. The method according to any one of items 14 through 19, further comprising adjusting the pH of the water.

21. The method according to item 20, wherein the adjusting of the pH is conducted prior to adding the polyol, after adding the polyol, or prior and after adding the polyol.

22. The method according to any one of items 14 through 21, wherein adjusting the pH includes adjusting to a pH greater than 4, such as greater than 4.5, greater than 5, greater than 5.5, greater than 6, greater than 7, greater than 8, greater than 9, greater than 9.5, greater than 10, greater than 10.1, greater than 10.2, greater than 10.3, greater than 10.4, or greater than 10.5.

23. The method according to any one of items 14 through 21, wherein adjusting the pH includes adjusting to a pH not greater than 12.5, not greater than 12, not greater than 11.5, such as not greater than 11, not greater than 10.8, not greater than 10.6, not greater than 10.4, not greater than 10.3, not greater than 10.2, not greater than 10.1, not greater than 10.

Experimentals

The following is the working protocol to prepare the fracturing fluid for viscosity profile determination:

Experiment 1

Three samples of guar gel were prepared, one sample in water containing no boron (NaB(OH)₄) and no sorbitol (see FIG. 1, dotted line), one sample in water containing boron (50 ppm as B) and no sorbitol (FIG. 1, dashed line), one sample in water containing boron (50 ppm as B) and sorbitol (3400 ppm) (FIG. 1, solid line). The guar concentration was 25 lbs/Mgal (pounds/thousand-gallon). After hydration at pH 6.5, a delayed-release borate was added and then the pH was raised to 12.

A volume required for testing was drawn with a syringe and loaded onto a Grace M5600 High Pressure High Temperature Viscometer. The tests were run for 30 minutes at 175° F. FIG. 1 depicts the viscosity profile for the viscosity profile of the three samples.

Experiment 2

Two samples of guar gel were prepared, one sample in water containing boron (NaB(OH)₄, 40 ppm as B) and no sorbitol (see FIG. 2, dashed line), one sample in water containing boron (40 ppm as B) and sorbitol (700 ppm) (FIG. 2, solid line). The guar concentration was 25 lbs/Mgal (pounds/thousand-gallon). The pH was maintained at 6.5 during guar hydration. After hydration, a delayed-release borate was added and then the pH was raised to 12.

FIG. 2 depicts the viscosity profile of the two samples. As can be seen in the graphs of FIG. 1 and FIG. 2, the presence of sorbitol inhibits initial viscosity spikes due to presence of low amounts of borate in the water.

1. A water source comprising a boron containing compound, having a boron concentration of not greater than 0.05 moles per liter, and a polyol, the polyol having a concentration of at least N times 0.05 moles per liter, wherein the water source is free of any boron-containing solid and has a dynamic viscosity of less than 100 cp.

2. The water source according to claim 1, wherein the boron containing compound is selected from the group consisting of boric acid, borate, tetrahydroxyborate, metaborate, polyborate, or any combination thereof.

3. The water source according to claim 1, wherein the polyol is selected from the group consisting of C₂-C₆ polyols, C₂-C₆ sugar alcohols, C₂-C₆ monosaccharides, disaccharides made from C₂-C₆ monosaccharides, trisaccharides made from C₂-C₆ monosaccharides, C₂-C₆ sugar acids, C₂-C₆ amino sugars, and any combination thereof.

4. The water source according to claim 1, wherein the polyol is selected from the group of glycols, glycerin, glucose, sorbitol, dextrose, mannose, mannitol, and any combination thereof.

5. The water source according to claim 1, wherein N is at least 0.1, such as at least 1.1, at least 1.5, at least 1.8, at least 2, at least 2.1, at least 2.2, at least 2.3, at least 2.4, at least 2.5, at least 3, at least 3.5, at least 4, at least 4.5, at least 5, at least 6, at least 8, at least 10, at least 20, at least 30, at least 40, at least 50, at least 75, at least 100.

6. The water source according to claim 1, wherein N is not greater than 1000, not greater than 900, not greater than 800, not greater than 700, not greater than 600, not greater than 500, not greater than 450, not greater than 400, not greater than 350, not greater than 300, not greater than 250, not greater than 200, not greater than 150, not greater than 125, not greater than 110, not greater than 90, not greater than 70, not greater than 50, not greater than 30, not greater than 25, or not greater than 15.

7. The water source according to claim 1, wherein the water source includes a well water source, a riparian water source, an aquifer water source, a lake water source, an ocean water source, a surface water source, a subterranean water source, an industrial water source, a waste water source, production water, flowback water, or any combination thereof.

8. The water source according to claim 1 further comprising a buffer.

9. The water source according to claim 1, wherein the water source has a pH greater than 4, such as greater than 4.5, greater than 5, greater than 5.5, greater than 6, greater than 7, greater than 8, greater than 9, greater than 9.5, greater than 10, greater than 10.1, greater than 10.2, greater than 10.3, greater than 10.4, or greater than 10.5.

10. The water source according to claim 1, wherein the water source has a pH not greater than 12.5, not greater than 12, not greater than 11.5, such as not greater than 11, not greater than 10.8, not greater than 10.6, not greater than 10.4, not greater than 10.3, not greater than 10.2, not greater than 10.1, not greater than 10.

11. The water source according to claim 1, wherein the boron concentration is a minimum of 9.25×10⁻⁸ moles per liter.

12. The water source according to claim 1, wherein the water source is in an amount of at least 100 gallons, at least 500 gallons, at least 1000 gallons, at least 1500 gallons, at least 2000 gallons, at least 5000 gallons, at least 7500 gallons, at least 10,000 gallons, at least 50,000 gallons, at least 100,000 gallons.

13. A method of treating a water source, the method comprising:
providing water from a water source, the water comprising a boron containing compound;
adding a polyol to the water.

14. A method of preparing a fracturing fluid, the method comprising:
providing water from a water source, the water comprising a boron containing compound;
adding a polyol to the water;
adding a polysaccharide-based polymer.

15. The method according to claim 14, wherein the wherein the polyol is selected from the group consisting of C₂-C₆ polyols, C₂-C₆ sugar alcohols, C₂-C₆ monosaccharides, disaccharides made from C₂-C₆ monosaccharides, trisaccharides made from C₂-C₆ monosaccharides, C₂-C₆ sugar acids, C₂-C₆ amino sugars, and any combination thereof.

16. The method according to claim 14, wherein the polyol is selected from the group of glycols, glycerin, glucose, sorbitol, dextrose, mannose, mannitol, and any combination thereof.

17. The method according to claim 14, further comprising determining a concentration of the boron containing compound.

18. The method according to claim 17, wherein the determining of the boron containing concentration is conducted prior to adding the polyol, after adding the polyol, or prior and after adding the polyol.

19. The method according to claim 14, further comprising adjusting the pH of the water.

20. The method according to claim 19, wherein the adjusting of the pH is conducted prior to adding the polyol, after adding the polyol, or prior and after adding the polyol.
